(19) United States
(12) Patent Application Publication
(10) Pub. No.: US 2006/0061455 A1
(43) Pub. Date: Mar. 23, 2006

(54) Multiple mass vibrator

(75) Inventor: Jari Nousiainen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/947,065

(22) Filed: Sep. 21, 2004

(51) Int. Cl. H04B 3/36

(52) U.S. Cl. 340/407.1

(57) ABSTRACT

A method and apparatus are provided for vibrating a device that uses multiple mass vibrators to vibrate the device. The multiple mass vibrators may include multiple independently rotating vibrators. The method includes one or more steps for controlling the rotational speed and relative phase vibrational forces of the multiple mass vibrators. The control may include using either triangular pulses, square wave pulses, or other suitable pulses. The multiple mass vibrators may be synthesized in approximately the same way as various waveforms can be synthesized from pure sine waves by controlling their frequency, amplitude and phase. The multiple mass vibrators may include multiple larger and smaller synchronized vibrators, as well as two or more mass vibrators having different masses, different shapes, different other suitable physical characteristics, or some combination thereof, so as to produce different vibratory effects when vibrated.

### BACKGROUND OF THE INVENTION

1. Field of Invention

The present invention relates to a method and apparatus for vibrating a device, such as a mobile phone or other suitable wireless device, node or terminal; and more particularly to a method and apparatus for vibrating a device using multiple mass vibrators to vibrate the same.

2. Description of Related Art

It is known in the prior art to vibrating device, including a mobile phone or terminal using some vibrating element contained therein. However, these devices typically having one vibrating mass, which limits the kind of vibrating effects that can be provided in the device. By way of example, the reader is referred to EP 101 12 49, which discloses one such device having an eccentric weight arranged on rotating shaft with a center of gravity misaligned with an axial center of the rotating shaft. In operation, the rotating weight is rotated in alternating directions so as to produce vibrations that are claimed to prevent substantially movement of the device when left unattended, so that the vibrating device does not fall off a table when unattended.

### SUMMARY OF INVENTION

In its broadest sense, the present invention provides a new and unique method and device for vibrating a device that uses multiple mass vibrators to vibrate the device.

The multiple mass vibrators may include multiple independently rotating vibrators. The method includes one or more steps for tightly controlling the rotational speed and relative phase vibrational forces of the multiple mass vibrators. The tight control may include using either triangular pulses, square wave pulses, or other suitable pulses. The multiple mass vibrators may be synthesized in approximately the same way as various waveforms can be synthesized from pure sine waves by controlling their frequency, amplitude and phase. The multiple mass vibrators may include multiple larger and smaller synchronized vibrators, as well as two or more mass vibrators having different masses, different shapes, different other suitable physical characteristics, or some combination thereof, so as to produce different vibratory effects when vibrated.

The invention may be implemented using pinions to limit the relative rotational phase difference of the multiple mass vibrators. The pinion may include a gear with a small number of teeth designed to mesh with a larger wheel or rack. In operation, the multiple mass vibrators create sharp vibrational effects for stimulating the user of the device, which may include a mobile phone or other suitable wireless device, node, terminal, etc., including either distinct vibratory signatures that are pre-programmed in the device and selected by a user, or that are programmed into the device by the user, or some combination thereof.

The multiple mass vibrators may vibrate the housing of the device or other suitable structure. In one embodiment, the multiple mass vibrators may include two vibrators rotating in different directions, including upward and downward in relation to a vertical axis of the device, as well as two or more mass vibrators moving in either different transverse directions, or different rotational directions, or some combination thereof.

The present invention also features a device having a vibrating device for vibrating the same, wherein the vibrating device includes multiple mass vibrators to vibrate the device. The device may include a multiple mass vibrators control module for controlling the rotational speed and relative phase vibrational forces of the multiple mass vibrators, in effect, by synthesizing the movement of the multiple mass vibrators. The device may include independent motors which can be controlled separately to control multiple mass vibrators to create, for example, a vibration in a certain direction.

The present invention also includes implementing the step(s) of the method via a computer program running in a processor or controller in such a mobile terminal, node or device, as well as a computer program product with a program code, which program code is stored on a machine readable carrier, for carrying out the step(s) of the aforementioned method when a computer program is run in a processor or control module of such a device.

One advantage of the present is that it by using multiple mass vibrators different kind of vibratory feelings can be generated, which can produce effects that are more complex than just using one vibrating mass. For example, instead of a sine wave feeling, the user may feel triangular wave feelings, even square wave feelings, any other wave feelings, or some combination thereof.

### BRIEF DESCRIPTION OF THE DRAWING

The drawing, not drawn to scale, includes the following Figures:

FIG. 1 shows a block diagram of a device according to the present invention.

FIG. 2 shows a diagram of two mass vibrators moving about a common axis in opposite rotational directions according to the present invention.

FIG. 3 shows a diagram of four mass vibrators having two corresponding pairs of corresponding different sized masses moving about a common axis in corresponding opposite rotational directions according to the present invention.

FIG. 4 shows a graph indicating resulting forces generated by four different vibrating mass in a device according to the present invention.

### DETAILED DESCRIPTION OF INVENTION

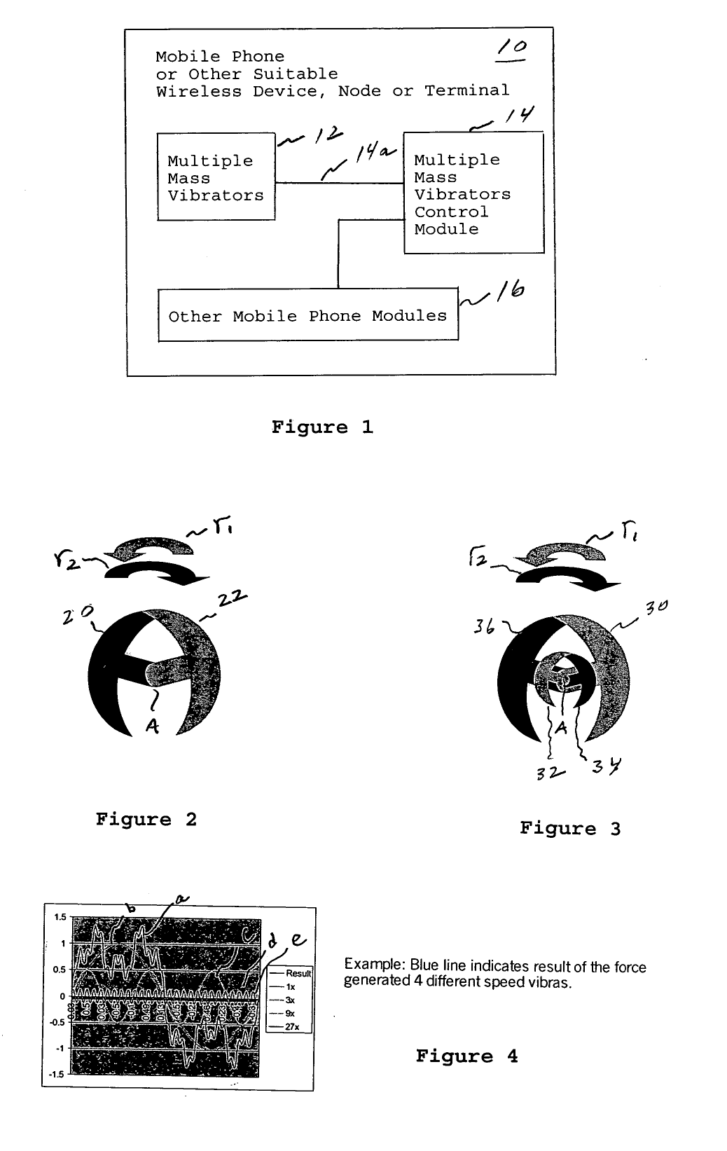

FIG. 1 shows a device generally indicated as 10 having a vibrating device with multiple mass vibrators 12 for vibrating the device 10. The device 10 may include a mobile phone, or other suitable wireless device, node or terminal that are known in the art, and the scope of the invention is not intended to be limited to any particular wireless device, node or terminal.

The multiple mass vibrators 12 may include multiple independently rotating vibrators as shown in FIGS. 2-3.

FIG. 2 shows, by way of example, one embodiment of the invention in which the multiple mass vibrators 12 include two mass vibrators 20, 22 moving or rotating about a common axis generally indicated as A in opposite rotational directions r₁, r₂. As shown, the two mass vibrators 20, 22 are moving in the same direction, either upward and downward in relation to a vertical axis of the device, although the scope of the invention is intended to include the two mass vibrators 20, 22 moving in different direction in relation to the vertical axis of the device. As a person skilled in the art would appreciate the two mass vibrators 20, 22 may be arranged on one or more motors or similar rotary devices known in the art for rotating the same. Moreover, as a person skilled in the art would appreciate the two mass vibrators 20, 22 may be arranged on one or more pinions, including to function to limit the relative rotational phase difference of the multiple mass vibrators 20, 22. The scope of the invention is not intended to be limited to any particular size, shape, weight, speed or period of movement, direction of movement, etc. of the two mass vibrators 20, 22, or the manner in which the two mass vibrators 20, 22 are rotated or moved in relation to one another. For example, the scope of the invention is intended to include using two or more mass vibrators 20, 22 having different masses, different shapes, different other suitable physical or translational characteristics, or some combination thereof, so as to produce different vibratory effects when moved or vibrated, as well as two or more mass vibrators 20, 22 arranged to move in either different linear directions, or different transverse directions, or different rotational directions, or some combination thereof.

FIG. 3 shows, by way of example, another embodiment of the invention in which the multiple mass vibrators 12 include four mass vibrators 30, 32; 34, 36 having two corresponding pairs 30, 32; 34, 36 of corresponding different sized masses 30, 36; 32, 34 moving about a common axis A in corresponding opposite rotational directions r₁, r₂. As shown, the corresponding different sized masses 30, 36; 32, 34 include multiple larger 30, 36 and smaller 32, 34 vibrators. Similarly, as a person skilled in the art would appreciate the four mass vibrators 30, 32; 34, 36 would be arranged on one or more motors or similar rotary devices known in the art for rotating the same. Moreover, as a person skilled in the art would also appreciate the two mass vibrators 30, 32; 34, 36 may be arranged on one or more pinions, including to function to limit the relative rotational phase difference of the multiple mass vibrators 20, 22. Similarly, the scope of the invention is not intended to be limited to any particular size, shape, weight, speed or period of movement, direction of movement, etc. of the four mass vibrators 30, 32; 34, 36, or the manner in which the two mass vibrators 30, 32; 34, 36, are rotated or moved in relation to one another. For example, the scope of the invention is intended to include using two or more mass vibrators 30, 32; 34, 36 having different masses, different shapes, different other suitable physical or translational characteristics, or some combination thereof, so as to produce different vibratory effects when moved or vibrated, as well as two or more mass vibrators 30, 32; 34, 36 arranged to move in either different linear directions, or different transverse directions, or different rotational directions, or some combination thereof.

FIG. 4 shows a graph of a resulting focus of the mass in one direction. The slope of the result curve indicates the generated force by the multiple mass vibrator. The result force, indicated by reference label a(result), can be generated, for example, by a combination of four synchronous forces indicated by reference labels b(1x), c(3x), d(9x), e(27x) produced from four different vibrating mass in a device according to the present invention.

### The Multiple Mass Vibrators Control Module 14

The device 10 also may include a multiple mass vibrators control module 14 for controlling the multiple mass vibrators 12 via a control signal 14a, including controlling the rotational speed and relative phase vibrational forces of the multiple mass vibrators 12. The multiple mass vibrators control module 14 may control the multiple mass vibrators 12, for example, using either triangular pulses, square wave pulses, or other suitable control pulses. In operation, the multiple mass vibrators control module 14 synthesizes the multiple mass vibrators 12 in approximately the same way or technique as various waveforms can be synthesized from pure sine waves by controlling their frequency, amplitude and phase. The multiple mass vibrators 22 create sharp vibrational effects, including either distinct vibratory signatures that are pre-programmed in the device 10 and selected by a user, or that are programmed into the device 10 by the user, or some combination thereof.

The functionality of the multiple mass vibrators control module 14 shown in FIG. 1 may be implemented using hardware, software, firmware, or a combination thereof in order to synthesize the movement of the multiple mass vibrators 12. In a typical software implementation, the module 14 would be one or more microprocessor-based architectures having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any particular implementation using technology known or later developed in the future.

### Other Mobile Phone or Device Modules 16

The device 10 may also include other mobile phone or device modules 16 that are known in the art, but do not necessarily form part of the basic invention disclosed herein, including a keyboard module, a memory module, input/output modules, a control module, etc.

### SCOPE OF THE INVENTION

The scope of the invention is not intended to be limited to any specific kind of device or user equipment, mobile terminal, phone or devices, and many different mobile terminals or devices, including laptop or notebook computers, as well as PDAs and tablet PCs, are envisioned that may contain the fundamental features of the present invention described herein.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method for vibrating a device, characterized in that the method includes using multiple mass vibrators to vibrate the device.

2. A method according to claim 1, wherein the multiple mass vibrators include multiple independently rotating vibrators.

3. A method according to claim 1, wherein the method includes controlling the speed and relative phase vibrational forces of the multiple mass vibrators, including the rotational speed.

4. A method according to claim 3, wherein the control includes using either triangular pulses, square wave pulses, or other suitable pulses.

5. A method according to claim 4, wherein the method includes synthesizing the multiple mass vibrators in approximately the same way as various waveforms can be synthesized from pure sine waves by controlling their frequency, amplitude and phase.

6. A method according to claim 1, wherein the multiple mass vibrators include multiple larger and smaller synchronized vibrators.

7. A method according to claim 1, wherein the method includes using pinions to limit the relative rotational phase difference of the multiple mass vibrators.

8. A method according to claim 6, wherein a pinion includes a gear with a small number of teeth designed to mesh with a larger wheel or rack.

9. A method according to claim 1, wherein the multiple mass vibrators create sharp vibrational effects, including either distinct vibratory signatures that are pre-programmed in the device and selected by a user, or that are programmed into the device by the user, or some combination thereof.

10. A method according to claim 1, wherein the device is a mobile phone or other suitable wireless device, node or terminal.

11. A method according to claim 1, wherein the multiple mass vibrators vibrate a housing of the device.

12. A method according to claim 1, wherein the movement of the multiple mass vibrators is synthesized by a multiple mass vibrators control module.

13. A method according to claim 1, wherein the multiple mass vibrators include two vibrators rotating in different directions, including upward and downward in relation to a vertical axis of the device.

14. A method according to claim 1, wherein the multiple mass vibrators include two or more mass vibrators having different masses, different shapes, different other suitable physical or translational characteristics, or some combination thereof, so as to produce different vibratory effects when vibrated.

15. A method according to claim 1, wherein the multiple mass vibrators include two or more mass vibrators moving in either different linear directions, or different transverse directions, or different rotational directions, or some combination thereof.

16. A method according to claim 1, wherein the multiple mass vibrators include two mass vibrators moving about a common axis in opposite rotational directions.

17. A method according to claim 1, wherein the multiple mass vibrators include four mass vibrators having two corresponding pairs of corresponding different sized masses moving about a common axis in corresponding opposite rotational directions.

18. A device having a vibrating device for vibrating the same, characterized in that the vibrating device includes multiple mass vibrators to vibrate the device.

19. A device according to claim 18, wherein the multiple mass vibrators include multiple independently rotating vibrators.

20. A device according to claim 18, wherein the device includes a multiple mass vibrators control module for controlling the speed and relative phase vibrational forces of the multiple mass vibrators, including the rotational speed.

21. A device according to claim 18, wherein the multiple mass vibrators control module controls the multiple mass vibrators using either triangular pulses, square wave pulses, or other suitable pulses.

22. A device according to claim 21, wherein the multiple mass vibrators control module synthesizes the multiple mass vibrators in approximately the same way as various waveforms can be synthesized from pure sine waves by controlling their frequency, amplitude and phase.

23. A device according to claim 18, wherein the multiple mass vibrators include multiple larger and smaller synchronized vibrators.

24. A device according to claim 18, wherein the device includes pinions to limit the relative rotational phase difference of the multiple mass vibrators.

25. A device according to claim 24, wherein a pinion includes a gear with a small number of teeth designed to mesh with a larger wheel or rack.

26. A device according to claim 18, wherein the multiple mass vibrators create sharp vibrational effects, including either distinct vibratory signatures that are pre-programmed in the device and selected by a user, or that are programmed into the device by the user, or some combination thereof.

27. A device according to claim 18, wherein the device is a mobile phone or other suitable wireless device, node or terminal.

28. A device according to claim 18, wherein the multiple mass vibrators vibrate the housing of the device.

29. A device according to claim 18, wherein the device includes a multiple mass vibrators control module synthesizes the movement of the multiple mass vibrators.

30. A device according to claim 18, wherein the multiple mass vibrators include two vibrators rotating in different directions, including upward and downward in relation to a vertical axis of the device.

31. A device according to claim 18, wherein the multiple mass vibrators include two or more mass vibrators having different masses, different shapes, different other suitable physical or translational characteristics, or some combination thereof, so as to produce different vibratory effects when vibrated.

32. A device according to claim 18, wherein the multiple mass vibrators include two or more mass vibrators arranged to move in either different linear directions, or different transverse directions, or different rotational directions, or some combination thereof.

33. A device according to claim 1, wherein the multiple mass vibrators include two mass vibrators moving about a common axis in opposite rotational directions.

34. A device according to claim 1, wherein the multiple mass vibrators include four mass vibrators having two corresponding pairs of corresponding different sized masses moving about a common axis in corresponding opposite rotational directions.

35. A method according to claim 1, wherein the method further comprises implementing the step of the method via a computer program running in a processor or controller in a device.

36. A computer program product with a program code, which program code is stored on a machine readable carrier, for carrying out steps of a method for using multiple mass vibrators to vibrate the device, when a computer program is run in a processor or control module of a device.

37. A mobile phone or other suitable wireless device, node or terminal having a vibrating device for vibrating the same therein, characterized in that
the vibrating device includes multiple independently rotating vibrators to vibrate the device; and
a multiple mass vibrators controller module for synthesizing or coordinating the movement of the multiple independently rotating vibrators.
